(19) United States
(12) Patent Application Publication
(10) Pub. No.: US 2004/0232634 A1
(43) Pub. Date: Nov. 25, 2004

(54) Removable wheel assembly for cart

(76) Inventors: Melvin L. Blackmon, Los Angeles, CA (US); John C. Phillips JR., Northridge, CA (US)

Correspondence Address: COUDERT BROTHERS LLP, 333 SOUTH HOPE STREET, 23RD FLOOR, LOS ANGELES, CA, 90071, US

(21) Appl. No.: 10/441,466

(22) Filed: May 20, 2003

(51) Int. Cl. B62B 1/00

(52) U.S. Cl. 280/47.26

(57) ABSTRACT

The present invention is an apparatus to removably attach wheels to an item, such as a golf bag, for easy transportation. According to one embodiment of the present invention, the device is made up of several individual components that are assembled for operation. These components include a belt, a pair of wheels, and a handle. The belt is secured around the base of a golf bag and includes means for tightening or firmly securing the belt onto the golf bag. A pair of wheels are mountable onto protruding axles on the belt. A handle is then added to the bag itself to make it easy to wheel the bag around a golf course. When disassembled, the apparatus can store easily even within a pocket on the golf bag itself This makes it instantly available to the golfer when desired.

### BACKGROUND OF THE INVENTION

1. Field of the Invention

The present invention is an apparatus to allow temporary addition of wheels to an item for transportation.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all rights whatsoever.

2. Background Art

Golf is a sport played on courses averaging a few thousand yards in area, and a golf game can average 3-5 hours. This means that the players have to carry their golf bags, or rent motorized carts for long periods of time and over large distances. Renting carts is one of the largest sources of income for a golf course, and renting one on a regular basis may be an undesirable expense for golfers. On the other hand, carrying the golf bags on the shoulder or back over large distances of a golf course makes the game even longer to play, and increases the chance of injuries.

Currently there are some alternatives to renting a golf cart or carrying a golf bag. One option is to buy or rent a hand cart. A hand cart is a wheeled device with a handle that receives a golf bag and allows the golfer to tow the bag on the wheels. In some cases, the prior art has provided a foldable hand cart that can be stored in an automobile trunk when not in use.

Prior art hand carts/caddies that fold are bulky and cumbersome to fold and unfold, and require considerable manpower to mount fully loaded bags onto the carts. On the other hand, prior art hand carts that do not fold need more space to store and haul and still require considerable manpower to mount golf bags onto them. So, we can see that prior art hand carts have disadvantages which many golf players try and avoid and as a result end up carrying their golf bags or renting a motorized cart.

### SUMMARY OF THE INVENTION

The present invention is an apparatus to removably attach wheels to an item, such as a golf bag, for easy transportation. According to one embodiment of the present invention, the device is made up of several individual components that are assembled for operation. These components include a belt, a pair of wheels, and a handle.

The belt is secured around the base of a golf bag and includes means for tightening or firmly securing the belt onto the golf bag. A pair of wheels is mountable onto protruding axles on the belt. A handle is then added to the bag itself to make it easy to wheel the bag around a golf course. When disassembled, the apparatus can store easily even within a pocket on the golf bag itself. This makes it instantly available to the golfer when desired.

### BRIEF DESCRIPTION OF THE DRAWINGS

These and other features, aspects and advantages of the present invention will become better understood with regard to the following description, appended claims and accompanying drawings where:

FIG. 1 is a plan view of a belt component according to one embodiment of the present invention.

FIG. 2 is an elevation view of a wheel and belt components according to one embodiment of the present invention.

FIG. 3 shows a plan view and an elevation view of a handle component according to one embodiment of the present invention.

### DETAILED DESCRIPTION OF THE INVENTION

The embodiments of the present invention are a device to move a bag, especially a golf bag. In the following description, numerous specific details are set forth to provide a more thorough description of embodiments of the invention. It will be apparent, however, to one skilled in the art, that the embodiments of the present invention may be practiced without these specific details. In other instances, well known features have not been described in detail so as not to obscure the invention.

The invention in one embodiment includes a belt for securing to the base of a golf bag, a pair of wheels, and a handle.

Belt Component of Device

The belt in one embodiment is made of a plastic mold or a heavy duty stiff nylon. The belt comprises of several components that are fixed onto it. The belt when laid flat on the ground has a pair of horizontal edges (a top and a bottom edge) separated by a distance, and a pair of vertical edges (a left and a right edge) separated by a distance such that the distance between the horizontal edges is comparatively shorter than the distance between the vertical edges. On the other hand, the length of the horizontal edges is comparatively longer than the length of the vertical edges. The length of the belt is such that it can circumvent around a golf bag fully loaded with equipment with room to spare, and the width of the belt is such that when the belt is strapped around an upright golf bag fully loaded with equipment and the wheels are attached to the belt it can keep the bag from toppling over.

According to one embodiment of the invention, there are a pair of angled rods which are each attached to a plate at one end of the belt. The plates are fixed onto the belt equidistance from the left and right edges and in the center of the top and bottom edges. The plates are fixed on the belt so that when the belt is strapped around a fully loaded golf bag, they align on either side of the bag. According to one embodiment of the rods, they are made of metal or heavy duty plastic and act as axle rods for the pair of wheels. According to another embodiment of the rods, they form an angle less than 90° between them and the top edge of the belt. According to another embodiment of the rods, they each have a pair of locking mechanisms, one on either side of the wheels when the wheels are mounted onto the rods. The inner locking mechanism keeps the wheels from scraping against the bag, and the outer locking mechanism keeps the wheel from coming loose or falling off the axle when in motion. Additionally, the angle of the rods to the belt also help the wheels from dismounting the rods when in motion. One preferred embodiment of the inner locking mechanism is an increase in the diameter of the rod between the wheel and the belt when the wheel is mounted onto the axle. One preferred embodiment of the outer locking mechanism is a hole in the axle between the wheel the end opposite the end attached to the plate when the wheel is mounted onto the axle through which a pin or bolt is attached.

According to another embodiment of the belt, there is a ratchet/belt system attached close to the vertical edges and oriented in the same direction as the belt when laid flat on the floor. The ratchet/belt system allows a user to increase or decrease the overall length of the belt as needed. It also aids in tightening or loosening the belt around a bag, such that the bag does not slide off the belt or come loose when the bag is being pulled. According to one embodiment of the ratchet/belt system, one end of each part of the system is attached close to the right and left edges respectively of the belt and in the center of the top and bottom edges.

According to another embodiment of the belt, there are a pair of straps oriented at 90° to the bottom edge of the belt and are fixed to the belt closer to the bottom edge and are equidistance between the two plates of the rods above. These straps are made of nylon, or Velcro®. According to another embodiment of the belt, there are a pair of D-rings closer to the bottom edge of the belt such that the distance above the bottom edge of the belt for the pair of straps and rings is the same. Each ring is fixed to the belt in the space between the plate of the rod and the ratchet/belt system.

In operation the belt is encompassed around the bag such that the bottom edge of the belt is aligned with the bottom (closed end) of the bag. The belt is tightened using the ratchet/belt system, so that it is securely wrapped around the bag such that the rods are on either side of the bag. The bag along with the securely attached belt is lifted to an upright position and the wheels are mounted onto the rods and locked in place at which point the bag is lifted off the floor. Once this is done, the pair of straps are taken under the bottom of the bag and tightened into the D-rings, providing additional support so that the bag does not slide to the floor when in an upright position.

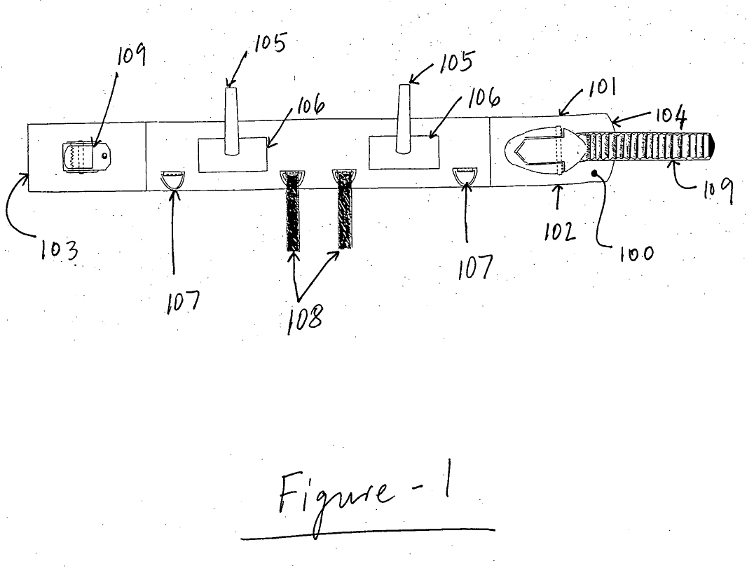

FIG. 1 illustrates a plan view of the belt component (100). The upper edge is marked 101, the lower edge 102, the left edge 103, and the right edge 104. The belt has several components fixed to it, and include angled rods (105) attached to plates 106, D-rings 107, straps 108, and a ratchet/belt system 109.

Wheel Component of Device

The wheels in one embodiment are made up of a layer of rubber tire surrounding a rim. According to one embodiment of the tire layer, it can be filled with air just like a bicycle or vehicle tire. According to another embodiment of the tire layer, it can be made of stiff rubber that does not require inflation. According to another embodiment of the tire layer, it has threads similar to a bicycle or vehicle tire. In operation once the belt is securely attached to the bag, each wheel is slipped down each angled rod attached to the belt. Once the wheels are in position, the outer locking mechanism is put in place so that the wheels do not come off the rods during motion.

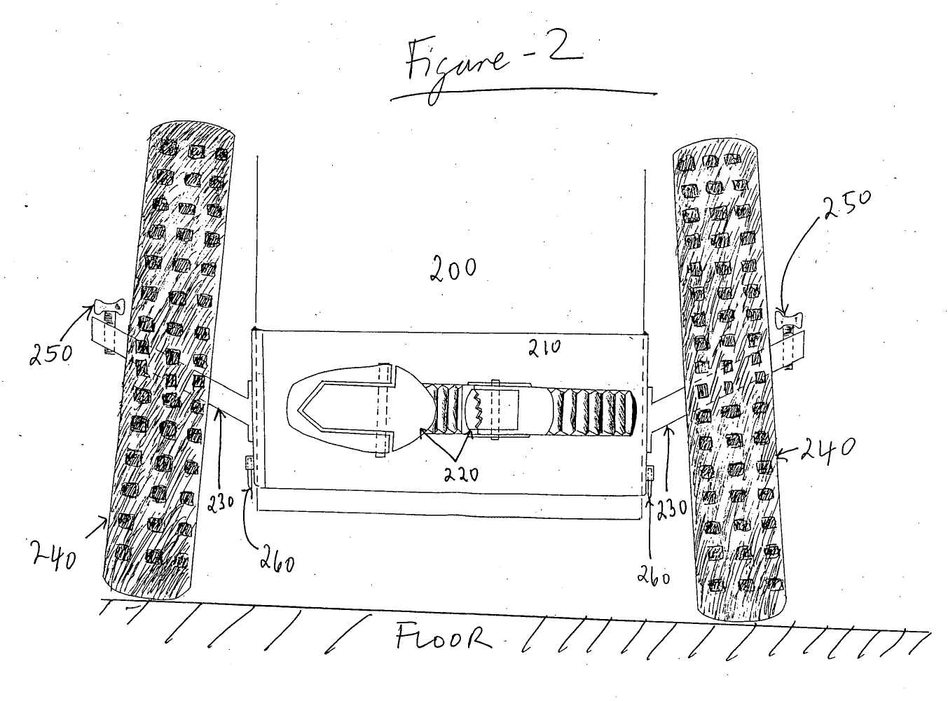

FIG. 2 illustrates an elevation view of the wheels attached to the rods. In the figure, the bag 200 is in an upright position with belt 210 securely attached to it using the ratchet/belt system 220. In this figure one can clearly see the orientation of the belt with respect to the bag. The two angled rods 230 protrude on either side of the bag and form and angle of 90° or less with the upright bag. The wheels 240 are slid down the rods until they are met with the inner locking mechanism of the rods (not shown). Once the wheels are in position, the outer locking mechanism 250 of the rods is put in place. One can also see in the figure that once the wheels are locked in place, the inner locking mechanism of the rods does not allow the wheels to scrap against the bag, the outer locking mechanism of the rods does not allow the wheels to slip off the rods when in motion, the bag is lifted clear of the floor, and the pair of D-rings (260) are on either side of the bag in a position to accept the straps (not shown).

Handle Component of Device

The handle, according to one embodiment, is made of metal or plastic. According to another embodiment of the handle, it has a spring loaded clamp at one end of the handle. According to another embodiment of the handle, the clamp can be a vise clamp. According to another embodiment of the handle, it has an opening on the end opposite the clamp end through which a user can grasp the handle. In operation the handle is tightened around a section of the top (open end) of the bag using the clamp as needed. In this position, the handle is generally oriented at right angles to the bag in an upright position (or conversely, the handle is generally oriented horizontally to the floor).

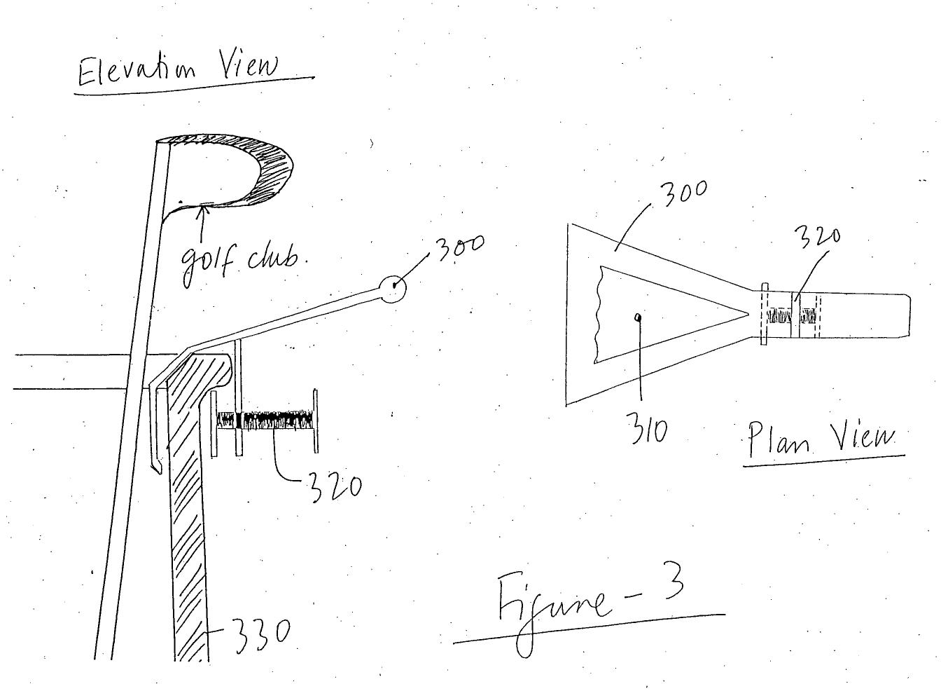

FIG. 3 illustrates a plan and an elevation view of the handle 300. 310 is the opening in the handle through which a user can grasp the handle. 320 is the clamp that can be tightened or loosened around the open (top) end of the bag. The figure also shows a side 330 of the bag with a golf club sticking out the top of the bag. From the elevation view, one can clearly see that when the handle is securely positioned, it is generally at right angles with the bag in an upright position.

Thus, a device to move a bag, especially a golf bag is described in conjunction with one or more specific embodiments. The invention is defined by the following claims and their full scope of equivalents.

I claim:

1. An apparatus comprising:
a flexible attaching means for coupling to a device to be transported;
a pair of wheels removably coupled to said attaching means.

2. The apparatus of claim 1 wherein said attaching means comprises a belt for wrapping around and securing a base of said device to be transported.

3. The apparatus of claim 2 wherein said belt further includes a pair of integral axles mounted thereon for receiving said wheels.

4. The apparatus of claim 1 further including a handle removably coupled to said device to be transported.

5. The apparatus of claim 3 wherein said device to be transported comprises a golf bag.

6. The apparatus of claim 3 further including an integral tightening device on said belt for tightening said belt around said device.
